(19) United States
(12) Patent Application Publication
(10) Pub. No.: US 2024/0183784 A1
(43) Pub. Date: Jun. 6, 2024

(54) SURFACE ENHANCED RAMAN SPECTROSCOPY METHOD OF PATHOGEN DETECTION AND SUBSTRATE FOR THE SAME

(71) Applicant: THE JOHNS HOPKINS UNIVERSITY, Baltimore, MD (US)

(72) Inventors: Kam Sang KWOK, Ellicott City, MD (US); Debadrita PARIA, Baltimore, MD (US); Ishan BARMAN, Baltimore, MD (US); David H. GRACIAS, Baltimore, MD (US)

(73) Assignee: THE JOHNS HOPKINS UNIVERSITY, Baltimore, MD (US)

(21) Appl. No.: 18/553,785

(22) PCT Filed: Apr. 11, 2022
(86) PCT No.: PCT/US2022/024259

§ 371 Date: Oct. 3, 2023

Related U.S. Application Data
(60) Provisional application No. 63/176,053, filed on Apr. 16, 2021.

(51) Int. Cl. G01N 21/65; B82Y 15/00; B82Y 40/00

(52) U.S. Cl. CPC G01N 21/658; B82Y 15/00; B82Y 40/00

(57) ABSTRACT

A surface-enhanced Raman spectroscopy (SERS) substrate, including a substrate base; and a plurality of metal insulator metal (MIM) nanostructures disposed on the substrate base, wherein an average distance between the plurality of MIM nanostructures disposed on the substrate base is from about 1 nm to about 10 nm, and a method of detecting at least one pathogen using the SERS substrate.

### CROSS-REFERENCE TO RELATED APPLICATIONS

This application is the national stage entry of International Patent Application No. PCT/US2022/024259, filed on Apr. 11, 2022, and published as WO 2022/221191 A1 on Oct. 20, 2022, which claims the benefit of U.S. Provisional Patent Application Ser. No. 63/176,053, filed Apr. 16, 2021, both of which are hereby incorporated by reference herein in their entireties.

### U.S. GOVERNMENT RIGHTS

This invention was made with Government support under grant CMMI-2033349, awarded by the National Science Foundation. The Government has certain rights in the invention.

### TECHNICAL FIELD

The present disclosure generally relates to the detection of pathogens and viruses, and more particularly, to surface enhanced Raman spectroscopy methods of pathogen detection and substrates for the same.

### BACKGROUND

The present COVID-19 pandemic has highlighted the need for efficient testing for viruses and pathogens. However, widespread use of currently available pathogen testing methods is hampered by sensitivity limitations, sample processing and storage requirements, and the requirement for complicated testing equipment, and/or multiple testing steps or chemical reagents. For example, real-time-polymerase chain reaction (RT-PCR) assays require expensive reagents and have been associated with undesirably high false negative results. Immunoassay-based approaches often require a long time for results, sometimes in the order of days. Approaches based on immune-chromatography strips may be faster, but often have a limit of detection several orders of magnitude lower than other immunoassay-based approaches.

Accordingly, there is a need for new highly sensitive and cost-efficient platforms for the detection of viruses and pathogens, such as SARS-CoV-2, and methods for the same, which could provide rapid results in point-of-care settings with minimal sample preparation.

### BRIEF SUMMARY

This summary is intended merely to introduce a simplified summary of some aspects of one or more implementations of the present disclosure. This summary is not an extensive overview, nor is it intended to identify key or critical elements of the present teachings, nor to delineate the scope of the disclosure. Rather, its purpose is merely to present one or more concepts in simplified form as a prelude to the detailed description below.

The foregoing and/or other aspects and utilities embodied in the present disclosure may be achieved by providing a surface-enhanced Raman spectroscopy (SERS) substrate, including a substrate base; and a plurality of metal insulator metal (MIM) nanostructures disposed on the substrate base, wherein an average distance between the plurality of MIM nanostructures disposed on the substrate base is from about 1 nm to about 10 nm, wherein each of the plurality of MIM nanostructures comprises one or more metal or metal oxide layers and one or more insulator layers, and wherein each of the one or more metal or metal oxide layers has an average thickness from about 20 nm to about 60 nm and each of the one or more insulator layers has an average thickness from about 5 nm to about 10 nm.

The SERS substrate can be configured to produce a Raman spectrum corresponding to a pathogen sample when examined under a Raman spectroscope.

At least one of the one or more insulator layers can be disposed directly on the substrate base between at least one of the one or more metal or metal oxide layers and the substrate base.

At least one of the plurality of MIM nanostructures can have two or more metal or metal oxide layers, and wherein at least one of the one or more insulator layers can be disposed between the two or more metal or metal oxide layers.

At least half of the plurality of MIM nanostructures can have three or more metal or metal oxide layers.

The plurality of MIM nanostructures can exhibit plasmonic activity in response to electromagnetic excitations having a frequency corresponding to a plasmon resonance frequency of the plurality of MIM nanostructures.

The substrate base can be flexible and include an elastomer, the elastomer including one or more of a flexible polymer, silicone, polysiloxane, latex, or combinations thereof.

The one or more metal or metal oxide layers can include at least one of gold, silver, copper, aluminum, or alloys or combinations thereof, and wherein the plurality of MIM nanostructures can further include one or more adhesion layers disposed between at least two of the one or more insulator layers, the one or more metal or metal oxide layers, or the substrate base.

The one or more metal or metal oxide layers can include at least one Al/Ge doped zinc oxides, heavily doped indium tin oxides, metal nitrides, graphene, molybdenum disulfide, tungsten disulfide, or combinations thereof.

The one or more insulator layers can include at least one of aluminum oxide, indium tin oxide, tin oxide, silicon dioxide, zinc oxide, or combinations thereof.

At least one of the substrate base and the at least one of the one or more insulator layers can be disposed directly on the substrate base is hydroxyl functionalized.

The foregoing and/or other aspects and utilities embodied in the present disclosure may be achieved by providing a Surface Enhanced Raman Spectroscopy (SERS) biosensor can include a SERS substrate including a substrate base; and a plurality of metal insulator metal (MIM) nanostructures disposed on the substrate base, wherein an average distance between the plurality of MIM nanostructures disposed on the substrate base is from about 1 nm to about 10 nm, wherein each of the plurality of MIM nanostructures comprises one or more metal or metal oxide layers and one or more insulator layers, and wherein each of the one or more metal or metal oxide layers has an average thickness from about 20 nm to about 60 nm and each of the one or more insulator layers has an average thickness from about 5 nm to about 10 nm, wherein the SERS biosensor can be configured to produce a Raman spectrum corresponding to a pathogen sample when examined under a Raman spectroscope.

The foregoing and/or other aspects and utilities embodied in the present disclosure may be achieved by providing a method for making a surface-enhanced Raman spectroscopy (SERS) substrate, including creating a nanopatterned structure; depositing a plurality of MIM nanostructures on the nanopatterned structure; removing the nanopatterned structure; depositing a carrying film over the plurality of MIM nanostructures; lifting the plurality of MIM nanostructures; transferring the plurality of MIM nanostructures to a stretched substrate base; and releasing the stretched substrate base, wherein after releasing the stretched substrate base, an average distance between the plurality of MIM nanostructures on the substrate base is from about 1 nm to about 10 nm, wherein each of the plurality of MIM nanostructures comprises one or more metal or metal oxide layers and one or more insulator layers, and wherein each of the one or more metal or metal oxide layers has an average thickness from about 20 nm to about 60 nm and each of the one or more insulator layers has an average thickness from about 5 nm to about 10 nm.

After releasing the stretched substrate base, at least one of the one or more insulator layers can be disposed directly on the substrate base between at least one of the one or more metal or metal oxide layers and the substrate base.

Creating a nanopatterned structure can include using nanoimprint lithography to create a nanopatterned structure.

Transferring the plurality of MIM nanostructures to a stretched substrate base can include hydroxyl functionalizing at least one of the substrate base or the plurality of MIM nanostructures.

The foregoing and/or other aspects and utilities embodied in the present disclosure may be achieved by providing a method of detecting at least one pathogen using a SERS substrate, including placing a sample on a SERS substrate; obtaining Raman spectral data corresponding to the sample; pre-processing the Raman spectral data corresponding to the sample; analyzing the Raman spectral data corresponding to the sample; and determining and reporting a presence of at least one pathogen in the sample, wherein the SERS substrate includes a substrate base; and a plurality of metal insulator metal (MIM) nanostructures disposed on the substrate base, wherein an average distance between the plurality of MIM nanostructures disposed on the substrate base is from about 1 nm to about 10 nm, wherein each of the plurality of MIM nanostructures comprises one or more metal or metal oxide layers and one or more insulator layers.

Each of the one or more metal or metal oxide layers can have an average thickness from about 20 nm to about 60 nm and each of the one or more insulator layers can have an average thickness from about 5 nm to about 10 nm.

Pre-processing the Raman spectral data corresponding to the sample can include background correcting and normalizing the Raman spectral data and creating at least one of a training set, a validation set, or a test set.

Analyzing the Raman spectral data corresponding to the sample can include analyzing the Raman spectral data by machine learning analysis and validated at least one of a training set, a validation set, or a test set to detect the presence of at least one pathogen in the sample.

Further areas of applicability will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The accompanying drawings, which are incorporated in, and constitute a part of this specification, illustrate implementations of the present teachings and, together with the description, serve to explain the principles of the disclosure. In the figures:

FIGS. 1-2 illustrate a surface-enhanced Raman spectroscopy (SERS) substrate according to an implementation of the present disclosure.

FIGS. 3-5 illustrates SEM images of a SERS substrate according to implementations of the present disclosure.

FIG. 6 illustrates a SERS substrate according to an implementation of the present disclosure.

FIG. 7 illustrates a method of making a rigid SERS substrate according to implementations of the present disclosure.

FIG. 8 illustrates a method of making a rigid SERS substrate according to implementations of the present disclosure.

FIG. 9 illustrates a method of making a flexible SERS substrate according to implementations of the present disclosure.

FIG. 10 illustrates a method of making a flexible SERS substrate according to implementations of the present disclosure.

FIG. 11 illustrates a method of detecting at least one pathogen using a SERS substrate according to implementations of the present disclosure.

FIG. 12 illustrates a Raman spectra according to implementations of the present disclosure.

FIG. 13 illustrates a Principal Component Analysis for Raman spectral dataset of different virus samples according to implementations of the present disclosure.

FIGS. 14A-D illustrate machine learning analysis according to an implementation of the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary implementations of the present teachings, examples of which are illustrated in the accompanying drawings. Generally, the same reference numbers will be used throughout the drawings to refer to the same or like parts.

Throughout the specification and claims, the following terms take the meanings explicitly associated herein, unless the context clearly dictates otherwise. Phrases, such as, “in an implementation,” “in certain implementations,” and “in some implementations” as used herein do not necessarily refer to the same implementation(s), though they may. Furthermore, the phrases “in another implementation” and “in some other implementations” as used herein do not necessarily refer to a different implementation, although they may. As described below, various implementations can be readily combined, without departing from the scope or spirit of the present disclosure.

As used herein, the term “or” is an inclusive operator, and is equivalent to the term “and/or,” unless the context clearly dictates otherwise. The term “based on” is not exclusive and allows for being based on additional factors not described, unless the context clearly dictates otherwise. In the specification, the recitation of “at least one of A, B, and C,” includes implementations containing A, B, or C, multiple examples of A, B, or C, or combinations of A/B, A/C, B/C, A/B/B/B/B/C, A/B/C, etc. In addition, throughout the specification, the meaning of “a,” “an,” and “the” include plural references. The meaning of “in” includes “in” and “on.” Similarly, implementations of the present disclosure may suitably comprise, consist of, or consist essentially of, the elements A, B, C, etc.

It will also be understood that, although the terms first, second, etc. can be used herein to describe various elements, these elements should not be limited by these terms. These terms are only used to distinguish one element from another. For example, a first object, component, or step could be termed a second object, component, or step, and, similarly, a second object, component, or step could be termed a first object, component, or step, without departing from the scope of the invention. The first object, component, or step, and the second object, component, or step, are both, objects, component, or steps, respectively, but they are not to be considered the same object, component, or step. It will be further understood that the terms “includes,” “including,” “comprises” and/or “comprising,” when used in this specification, specify the presence of stated features, steps, operations, elements, and/or components, but do not preclude the presence or addition of one or more other features, steps, operations, elements, components, and/or groups thereof. Further, as used herein, the term “if” can be construed to mean “when” or “upon” or “in response to determining” or “in response to detecting,” depending on the context.

All physical properties that are defined hereinafter are measured at 20° to 25° Celsius unless otherwise specified.

When referring to any numerical range of values herein, such ranges are understood to include each and every number and/or fraction between the stated range minimum and maximum, as well as the endpoints. For example, a range of 0.5% to 6% would expressly include all intermediate values of, for example, 0.6%, 0.7%, and 0.9%, all the way up to and including 5.95%, 5.97%, and 5.99%, among many others. The same applies to each other numerical property and/or elemental range set forth herein, unless the context clearly dictates otherwise.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges. The terms “about” or “substantial” and “substantially” or “approximately,” with reference to amounts or measurement values, are meant that the recited characteristic, parameter, or values need not be achieved exactly. Rather, deviations or variations, including, for example, tolerances, measurement error, measurement accuracy limitations, and other factors known to those skilled in the art, may occur in amounts that do not preclude the effect that the characteristic was intended to provide. As used herein, “about” is to mean within +/−5% of a stated target value, maximum, or minimum value.

As used herein, “free” or “substantially free” of a material or substance may refer to when the material is present in an amount small enough to have zero or negligible effects on a desired result. For example, an atmosphere may be “free” or “substantially free” or substantially free of oxygen if the amount of oxygen has at most a negligible effect. In some implementations, “free” or “substantially free” may refer to less than 20 ppm, less than 10 ppm, and less than 5 ppm, of a specific material, such as oxygen or hydrogen. In other implementations, “free” or “substantially free” may refer to less than 50 ppb, less than 30 ppb, and less than 15 ppb, of a specific material, such as oxygen or hydrogen.

Unless otherwise specified, all percentages and amounts expressed herein and elsewhere in the specification should be understood to refer to percentages by weight. The percentages and amounts given are based on the active weight of the material. For example, for an active ingredient provided as a solution, the amounts given are based on the amount of the active ingredient without the amount of solvent or may be determined by weight loss after evaporation of the solvent.

With regard to procedures, methods, techniques, and workflows that are in accordance with some implementations, some operations in the procedures, methods, techniques, and workflows disclosed herein can be combined and/or the order of some operations can be changed.

The inventors have developed a new method for the rapid and label-free detection of viruses and pathogens, such as SARS-CoV-2, and substrates and biosensors incorporating the same. The new method combines nanoimprint lithography (NIL), surface-enhanced Raman spectroscopy (SERS), and machine learning (ML) for rapid and cost-efficient detection of viruses and pathogens using SERS substrates with high sensitivity and specificity.

As used herein, “Raman spectroscopy” refers to the spectroscopic technique involving the interaction of externally applied electromagnetic field, such as from a laser, with molecular vibrations, leading to Raman scattering. A small amount of the scattered photon is at a different energy than that of the excitation photon and the difference is quantified as the “Raman Shift.” Every molecule can have a unique “Raman Spectrum” that may serve as a fingerprint to identify the molecule through its vibrational energy spectrum.

As used herein “Surface Enhanced Raman Spectroscopy (SERS)” refers to the use of a metallic nanoparticle/nanostructured surface to increase the interaction between the incident electric field and the measured molecules, resulting in Raman spectra that is more easily observable.

As used herein, the term “label-free” refers to the lack of external labels (such as standard Raman reporters, fluorescence molecules, or chemical agents) that help in the direct identification of a sample under investigation by well-known Raman spectra, conventional microscopy, and/or commonly used chemical or visual inspection methods.

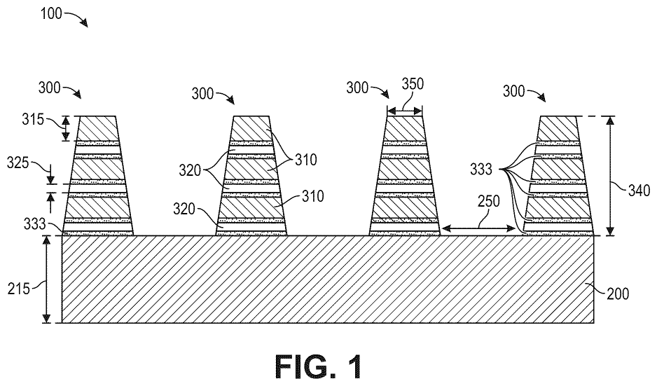

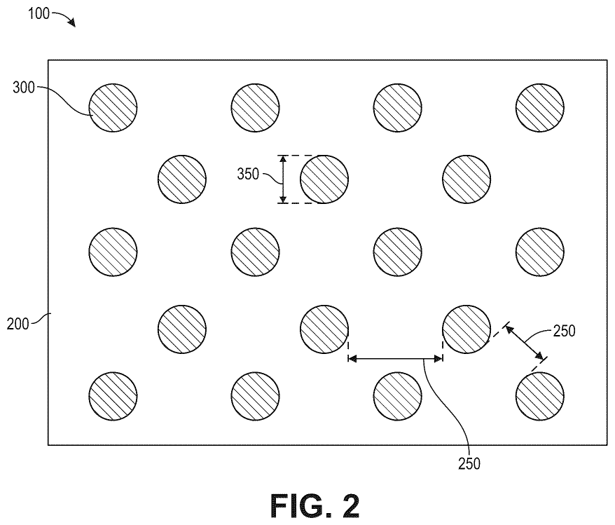

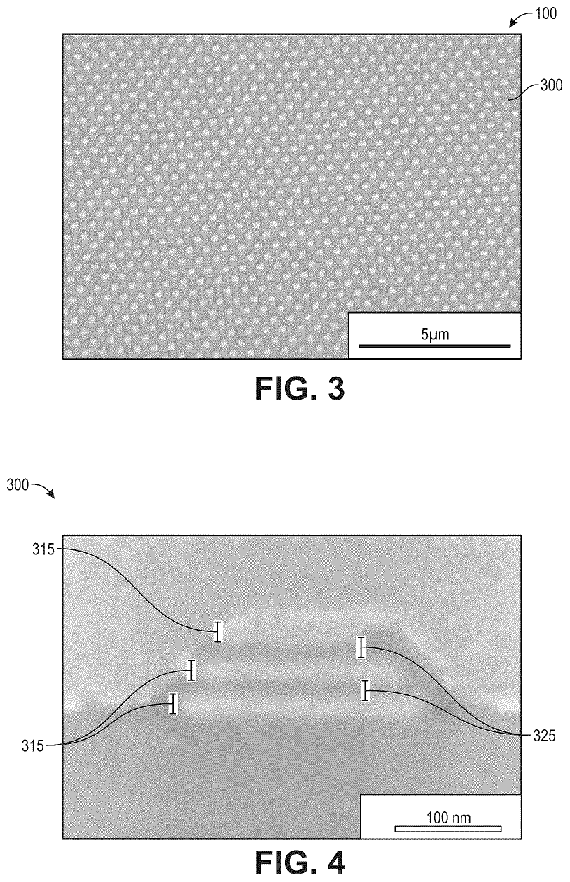

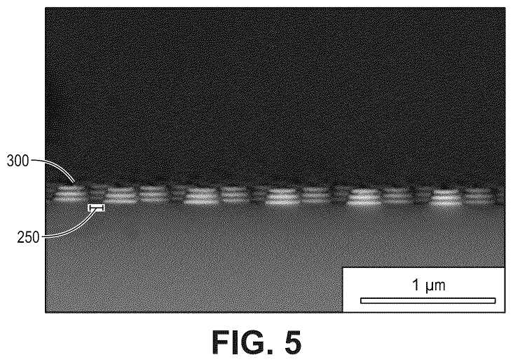

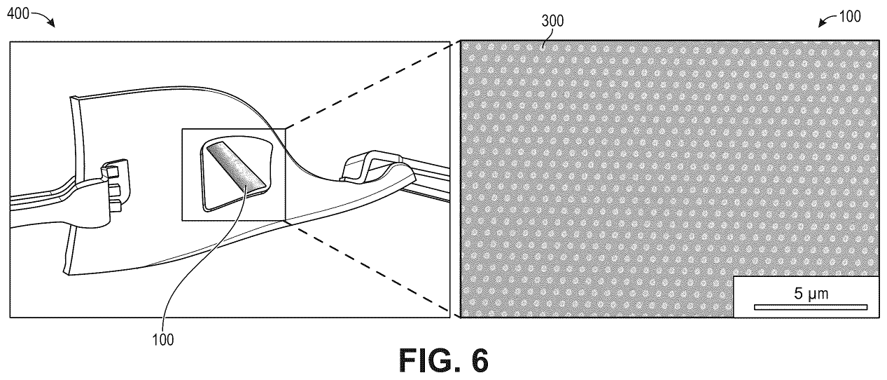

FIGS. 1-2 illustrate a surface-enhanced Raman spectroscopy (SERS) substrate according to an implementation of the present disclosure. FIGS. 3-5 illustrates SEM images of a SERS substrate according to implementations of the present disclosure. FIG. 6 illustrates a SERS substrate according to an implementation of the present disclosure. The SEM images of FIGS. 3-5 were taken in vacuum at a pressure of 1×10⁻⁶ Pa using a Thermo Scientific Helios G4 UC at less than 1 nm resolution.

As illustrated in FIGS. 1-6, a surface-enhanced Raman spectroscopy (SERS) substrate 100 includes a substrate base 200 and a plurality of metal insulator metal (MIM) nanostructures 300 disposed on the substrate base 200.

An average distance 250 between the plurality of MIM nanostructures 300 disposed on the substrate base 200 can be from about 1 nm to about 10 nm. For example, the substrate base 200 can be flexible, and an average distance 250 between the plurality of MIM nanostructures 300 can be from about 1 nm to about 10 nm, from about 1 nm to about 7 nm, from about 1 nm to about 5 nm, about 10 nm or less, or about 5 nm or less.

In other implementations, an average distance 250 between the plurality of MIM nanostructures 300 disposed on the substrate base 200 can be from about 100 nm to about 300 nm. For example, the substrate base 200 can be rigid, and an average distance 250 can be from about 100 nm to about 200 nm, from about 150 nm to about 300 nm, or from about 300 nm to about 350 nm.

An average density of the plurality of MIM nanostructures 300 on the substrate base 200 can be from about 2.86×10⁶ per square inch to about 1.03×10⁶ per square inch. For example, an average density of the plurality of MM nanostructures 300 on the substrate base 200 can be from about 7.17×10⁵ per square inch to about 5.27×10⁵ per square inch or can be about 4.23×10⁴ per square inch.

The average distance or density of the plurality of MM nanostructures 300 on the substrate base 200 can be measured by methods known in the art. For example, the average distance or density can be measure with a field emission scanning electron microscope and/or a laser scanning microscope.

As illustrated in FIGS. 1-6, each of the plurality of MIM nanostructures 300 has an average diameter 350 from about 100 nm to about 300 nm. For example, each of the plurality of MIM nanostructures 300 can have a diameter 350 from about 120 nm to about 220 nm or from about 180 nm to about 240 nm. Each of the plurality of MIM nanostructures 300 has an average height 340 from about 90 nm to about 110 nm. For example, each of the plurality of MIM nanostructures 300 can have an average height 340 from about 95 nm to about 105 nm or from about 93 nm to about 105 nm.

The substrate base 200 can have an average thickness 215 from about 250 m to about 5 cm. For example, the substrate base 200 can have a thickness 215 from about 381 m to about 406 m or from about 1 mm to about 5 cm. In other implementations, the substrate base 200 has a thickness 215 of about 40 mm or less, about 30 mm or less, about 20 mm or less, about 10 mm or less, about 5 mm or less, or about 1 mm or less. In yet other implementations, the substrate base 200 has a thickness 215 from about 250 to about 1000 m, from about 250 m to about 750 m, or from about 250 m to about 500 m.

The substrate base 200 can include one or more of an elastomer, a polymer, a glass, or combinations thereof. For example, the substrate base 200 can include at least one of glass, polycarbonate, plastic, non-woven fabrics, or combinations thereof. In some implementations, the substrate base 200 is flexible. For example, the substrate base 200 can include an elastomer or flexible polymer. The flexible substrate base 200 can be configured to stretch from a first length 202 to a second length 201, wherein the first length 202 is smaller than the second length 201. The flexible substrate base 200 can be resilient, configured to stretch and retract without ripping or other structural damage. In other implementations, the substrate base 200 is rigid. For example, the substrate base 200 can include a solid substrate or glass. The elastomer can include one or more of silicone, polysiloxane, latex, or combinations thereof. In other implementations, the substrate base 200 includes a polymer, such as a flexible polymer. The polymer can include one or more of polyvinyl alcohol, polymethyl methacrylate, poly(lactic-co-glycolic acid, polystyrene polyvinyl chloride, polyethylene, polyurethane, polyethylene glycol, or combinations thereof.

The substrate base 200 can be implemented in a variety of shapes. For example, the substrate base 200 can be flat, spherical, or cylindrical. In some implementations, the substrate base 200 is configured to adapt to a shape where installed. For example, the substrate base 200 can conform to a spherical or rounded shape of a surface where installed.

As illustrated in FIGS. 1 and 4, each of the plurality of MIM nanostructures 300 includes one or more metal or metal oxide layers 310 and one or more insulator layers 320. At least one of the one or more insulator layers 320 can be disposed between the one or more metal or metal oxide layers 310 and the substrate base 200. For example, at least one of the one or more insulator layers 320 can be disposed directly on the substrate base 200 between at least one of the one or more metal or metal oxide layers 310 and the substrate base 200. As described below, the insulator layers 320 can form an irreversible chemical bonding with a surface of the substrate base 200 to allow for large area transfer printing. At least one of the one or more insulator layers 320 can be disposed between the one or more metal or metal oxide layers 310. For example, at least one of the plurality of MIM nanostructures 300 can have two or more metal or metal oxide layers 310, and at least one of the one or more insulator layers 320 can be disposed between the two or more metal or metal oxide layers 310. The insulator layers 320 can allow the inter-metallic structure of each MIM nanostructures 300 near field-coupling for stronger light-matter interactions. In other implementations, the insulator layers 320 can prevent direct charge transfer between two metal or metal oxide layers 310 and the damping of plasmonic activity.

In some implementations, each of the plurality of MIM nanostructures 300 can also include one or more adhesion layers 333. For example, an adhesion layer 333 can be disposed between the one or more insulator layers 320 and the one or more metal or metal oxide layers 310 and/or between the substrate base 200 and one or more insulator layers 320 or the one or more metal or metal oxide layers 310. The one or more adhesion layers 333 can include metals, such as chromium (Cr), titanium (Ti), and nickel (Ni). The one or more adhesion layers 333 can have an average thickness up to about 2 nm. For example, the one or more adhesion layers 333 can have an average thickness of about 2 nm. In some implementations, the one or more adhesion layers 333 are used only between the one or more insulator layers 320 and the one or more metal or metal oxide layers 310. In other implementations, there is no adhesion layer 333 between the one or more insulator layers 320 and a release layer 701 disposed on the substrate base 200. In some implementations, the one or more adhesion layers 333 have a high affinity for oxygen. For example, the one or more adhesion layers 333 can have a high affinity for oxide materials, such as SiO₂, and can form intermetallic bonds with metals. Accordingly, the plurality of MIM nanostructures 300 can further include one or more adhesion layers 333 disposed between at least two of the one or more insulator layers 320, the one or more metal or metal oxide layers 310, or the substrate base 200.

Each of the one or more metal or metal oxide layers 310 can have an average thickness 315 from about 20 nm to about 60 nm. For example, each of the one or more metal or metal oxide layers 310 can have a thickness 315 from about 20 nm to about 30 nm, from about 20 nm to about 50 nm, or from about 50 nm to about 60 nm. Each of the one or more insulator layers 320 can have an average thickness 325 from about 5 nm to about 10 nm. For example, each of the one or more insulator layers 320 can have a thickness 325 from about 1 nm to about 5 nm or from about 5 nm to about 10 nm.

In one implementation, at least one of the plurality of MIM nanostructures 300 has two or more metal or metal oxide layers 310. In another implementation, at least one of the plurality of MIM nanostructures 300 has three or more metal or metal oxide layers 310. For example, at least half of the plurality of MIM nanostructures 300 has two or more metal or metal oxide layers 310 or has three or more metal or metal oxide layers 310.

The plurality of MIM nanostructures 300 are configured to exhibit plasmonic activity. For example, the plurality of MIM nanostructures 300 exhibit plasmonic activity and/or create electromagnetic field enhancing sites or hotspots in response to electromagnetic excitations having a frequency corresponding to a plasmon resonance frequency of the plurality of MIM nanostructures 300. Along with near field enhancement at the individual metal or metal oxide layers 310 of the MIM nanostructures 300, additional near field coupling can be enabled by the presence of adjacent metal or metal oxide layers 310 separated with an insulator layer 320.

Accordingly, the plurality of MIM nanostructures 300 include materials capable of demonstrating plasmonic activity. For example, the one or more metal or metal oxide layers 310 can include at least one of gold, silver, copper, platinum aluminum, or alloys or combinations thereof. The one or more metal or metal oxide layers 310 can include nanoporous gold (Au-np) or can consist essentially of Au-np. The one or more metal or metal oxide layers 310 can include silver (Ag) or can consist essentially of Ag.

In other implementations, the one or more metal or metal oxide layers 310 can include any engineered, highly doped semiconductor, transition metal oxide or 2D material, which exhibits plasmonic activity. For example, the one or more metal or metal oxide layers 310 can include at least one of Al/Ge doped zinc oxides, heavily doped indium tin oxides, metal nitrides, such as titanium nitride, zirconium nitride, tantalum nitride and hafnium nitride, 2D materials such as graphene, molybdenum disulfide, tungsten disulfide, or combinations thereof.

The one or more insulator layers 320 can include silica, oxides, polymers, semiconductor materials, or combinations thereof. For example, each of the one or more insulator layers 320 can include at least one of aluminum oxide, indium tin oxide, tin oxide, silicon dioxide, zinc oxide, silicon, germanium, or combinations thereof. The insulator layers 320 can allow the inter-metallic structure of the metal or metal oxide layers 310 near field coupling for stronger light-matter interactions and can prevent direct charge transfer between two metal or metal oxide layers 310 and the damping of plasmonic activity.

In some implementations, the plurality of MIM nanostructures 300 can be functionalized for better specificity and multiplexing. As used herein, the term “specificity” refers to a detection scheme tailor-made for a particular target molecule/pathogen. As used herein the term “multiplexing” refers to an ability to use the same platform/sensor to detect two or more different molecules/pathogens. For example, at least one of the plurality of MIM nanostructures 300 can be functionalized by chemical modification, such as with amine groups, polyethylene glycol (PEG), and/or streptavidin. In some embodiments, at least one of the plurality of MIM nanostructures 300 can be hydroxyl functionalized to enhance bonding. For example, at least one of the substrate base 200 and the at least one of the one or more insulator layers 320 disposed directly on the substrate base 200 can be hydroxyl functionalized. At least one of the plurality of MIM nanostructures 300 can be functionalized by biological markers, such as antibody, protein, or DNA labels. At least one of the plurality of MIM nanostructures 300 can be functionalized by attachment to fluorophores or Raman reporters. As used herein, the term “functionalization” refers to the surface modification with chemical/biological agents such that the surface has the ability to bind/conjugate with a particular target agent or pathogen. By functionalizing the MIM nanostructures 300 with two or more different chemical/biological species, capture and detection of different pathogens can be achieved (multiplexing). Further, attaching fluorophores labels will enable better imaging when the species is captured onto the surface. Attaching Raman reporter will enable a strong known Raman signature when the pathogen is captured on the surface. These label adding techniques, although not label-free, will enhance the specificity further.

The SERS substrate 100 is configured to produce a Raman spectrum corresponding to a pathogen sample when examined under a Raman spectroscope. For example, the SERS substrate 100 can produce a Raman spectrum corresponding to at least one of bacteria and/or virus and their mutated forms or their protein or DNA/RNA compositions. The SERS substrate 100 can produce a Raman spectrum for at least one of SARS-CoV-2, Influenza virus, Marburg virus, Zika, or combination thereof. In one implementation, the SERS substrate 100 can produce a Raman spectrum for SARS-CoV-2. While the present disclosure is described with respect to the pathogens described above, the present disclosure is not limited thereto, and the methods described herein may also work for viruses or pathogens that have a genome surrounded by a protein envelope.

As illustrated in FIG. 6, the SERS substrate 100 can be incorporated in a variety of biosensors. For example, a Surface Enhanced Raman Spectroscopy (SERS) biosensor 400 can include the SERS substrate 100. In some implementations, a SERS biosensor 400 incorporating the SERS substrate 100 is configured to produce a Raman spectrum corresponding to a pathogen sample when examined under a Raman spectroscope.

In some implementations, the SERS biosensor 400 can be embodied as an adhesive bandage, hydrogel, transparent film including the SERS substrate 100. In other implementations, the SERS biosensor 400 can be embodied as a glass lens or window including the SERS substrate 100.

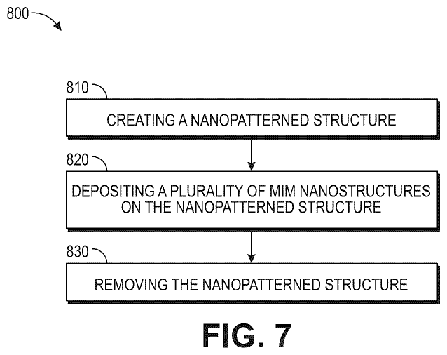

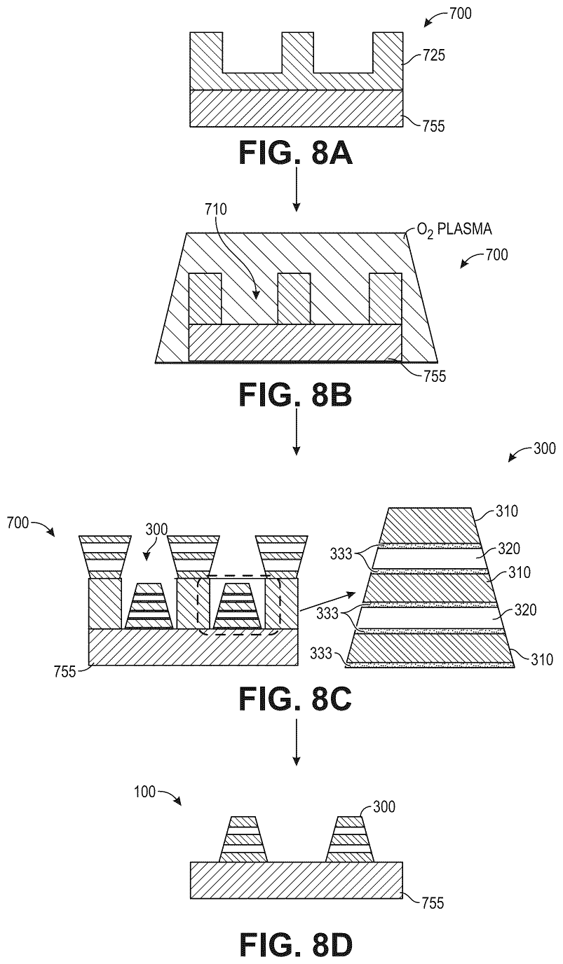

FIGS. 7-8 illustrate methods of making a rigid SERS substrate according to implementations of the present disclosure. The method illustrated in FIGS. 7-8, for instance, could be used to make a SERS substrate 100 as described above and as illustrated in FIGS. 1-6. As such, the discussion below will reference various components as illustrated in FIGS. 1-6.

As illustrated in FIGS. 7-8, a method 800 for making a surface-enhanced Raman spectroscopy (SERS) substrate 100 includes creating a nanopatterned structure in operation 810. For example, a nanopatterned structure 700 can be created via nanoimprint lithography (NIL). NIL fabrication allows scalable and affordable fabrication of the nanopatterned structure 700 in a rapid manner compared to other fabrication techniques. In other implementations, the nanopatterned structure 700 can be created via e-beam lithography, soft lithography, deep UV lithography, extreme UV lithography, and/or interference lithography.

As illustrated in FIG. 8, the SERS substrate 100 can be rigid, and creating a nanopatterned structure 700 can include depositing and patterning a thermoplastic, such as a NIL resist 725, on a rigid substrate 755. The rigid substrate 755 can be selected according to the NIL resist 725 used. For example, the rigid substrate 755 can include a silicon wafer. In other implementations, the rigid substrate 755 can include at least one of a silicon wafer, a glass wafer, a thermoplastic substrate, or combinations thereof. The NIL resist 725 can include formulations suitable for thermal and photo (UV) nanoimprint lithography, such as a PMMA e-beam resist, a Nanonex NIL resist, and a micro-resist-technology NIL resist. As illustrated in FIG. 8A, the NIL resist 725 can be deposited by, for example, spin coating the rigid substrate 755. The NIL resist 725 can be patterned by stamping, hot embossing, or imprinting a desired shape to the deposited NIL resist 725, for example by thermal and UV patterning methods. The NIL resist 725 can be further processed to remove any residue and to define a plurality of cavities 710. For example, as illustrated in FIG. 8B, the NIL resist 725 can be exposed to oxygen (02) plasma to remove any residue and to define a plurality of cavities 710. In some implementations, at least a portion of the rigid substrate 755 is exposed to form the plurality of cavities 710. For example, as illustrated in FIGS. 8B-8C, exposed portions of the rigid substrate 755 by the plurality of cavities 710 can correspond to a size of at least one of the plurality of MIM nanostructures 300 that will be deposited on the rigid substrate 755.

Operation 820 includes depositing a plurality of MM nanostructures on the nanopatterned structure. For example, as illustrated in FIG. 8C, one or more metal or metal oxide layers 310 and/or one or more insulator layers 320 can be deposited on the nanopatterned structure 700 to form a plurality of MIM nanostructures 300. The one or more metal or metal oxide layers 310 and/or one or more insulator layers 320 can be deposited via thermal evaporation, e-beam evaporation, and/or sputtering. In some implementations, masking is required either before (thermal and e-beam evaporation) or after the deposition (sputtering). In some implantations, the one or more metal or metal oxide layers 310 and/or one or more insulator layers 320 are deposited within the plurality of cavities 710.

As illustrated in FIG. 8C, the one or more metal or metal oxide layers 310 and/or one or more insulator layers 320 can be deposited directly on the substrate 750 and within the plurality of cavities 710. At least one of the one or more insulator layers 320 can be disposed between the one or more metal or metal oxide layers 310.

In some implementations, an adhesion layer 333 can be disposed between the insulator layers 320 and the metal or metal oxide layers 310 and/or between the substrate base 200 and the insulator layers 320 or the metal or metal oxide layers 310 to improve adhesion between the metal or metal oxide layers 310, the insulator layers 320, and/or the rigid substrate 755.

Operation 830 includes removing the nanopatterned structure. For example, as illustrated in FIG. 8D, removing the nanopatterned structure can include removing the NIL resist 725 from the rigid substrate 755. The NIL resist 725 can be remove using solvents and/or mechanical processes. For example, the NIL resist 725 can be removed by dissolving the NIL 725 in acetone and/or subjecting the NIL resist 725 to sonification. In other implementations, the NIL resist can be removed using organic solvents, such as acetone, N-Methyl-2-pyrrolidone (NMP) and toluene. As illustrated in FIG. 8D, a SERS substrate 100 with a rigid substrate 755 can be formed after removal of the nanopatterned structure 700.

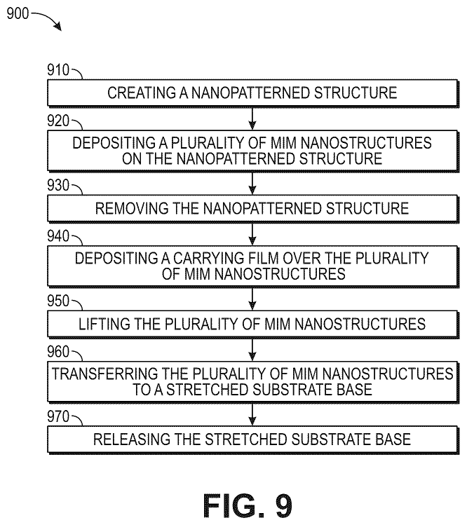

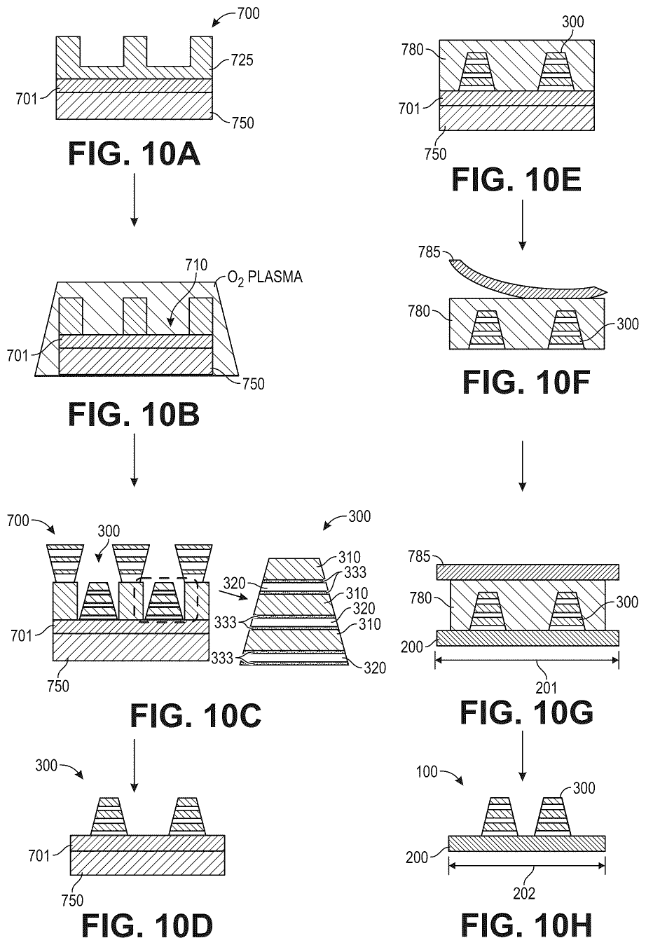

FIGS. 9-10 illustrate methods of making a flexible SERS substrate according to implementations of the present disclosure. The method illustrated in FIGS. 9-10, for instance, could be used to make a SERS substrate 100 as described above and as illustrated in FIGS. 1-6. As such, the discussion below will reference various components as illustrated in FIGS. 1-6.

As illustrated in FIGS. 9-10, a method 900 for making a surface-enhanced Raman spectroscopy (SERS) substrate 100 includes creating a nanopatterned structure in operation 910. A nanopatterned structure 700 can be created via nanoimprint lithography (NIL). For example, creating a nanopatterned structure can include using nanoimprint lithography to create a nanopatterned structure 700. In other implementations, the nanopatterned structure 700 can be created via e-beam lithography, soft lithography, deep UV lithography, extreme UV lithography, and/or interference lithography.

As illustrated in FIG. 10, the SERS substrate 100 can be flexible, and creating a nanopatterned structure 700 can include depositing and patterning a thermoplastic, such as a NIL resist 725, on a base substrate 750 including a release layer 701. As illustrated in FIG. 10A, a release layer 701 can be deposited on a base substrate 750. The release layer 701 can be deposited by, for example, thermal evaporation. The release layer 701 can be selected according to the NIL resist used. For example, the resist layer 701 can include a germanium (Ge). The base substrate 750 can be selected according to the NIL resist used. For example, the base substrate 750 can include a silicon wafer. In other implementations, the base substrate 750 can include at least one of a silicon wafer, a glass substrate, a thermoplastic substrate, or combinations thereof. As described above, the NIL resist can include formulations suitable for thermal and photo (UV) nanoimprint lithography. As illustrated in FIG. 10A, the NIL resist 725 can be deposited by, for example, spin coating on the release layer 701. The NIL resist 725 can be patterned by stamping, hot embossing, or imprinting a desired shape to the deposited NIL resist 725. The NIL resist 725 can be further processed to remove any residue and to define a plurality of cavities 710. For example, as illustrated in FIG. 10B, the NIL resist can be exposed to oxygen (02) plasma to remove any residue and to define a plurality of cavities 710. In some implementations, at least a portion of the release layer 701 is exposed to form the plurality of cavities 710. For example, as illustrated in FIGS. 10B-10C, exposed portions of the release layer 701 by the plurality of cavities 710 can correspond to a size of at least one of the plurality of MIM nanostructures 300 that will be deposited on the base substrate 750. In some implementations, the release layer 701 has a high etch selectivity to water. In some implementations, the MIM nanostructures 300 are water resistant or water insoluble. For example, water does not oxidize or etch away the MIM nanostructures 300.

Operation 920 includes depositing a plurality of MIM nanostructures on the nanopatterned structure. For example, as illustrated in FIG. 10, one or more metal or metal oxide layers 310 and/or one or more insulator layers 320 can be deposited on the nanopatterned structure 700 to form a plurality of MIM nanostructures 300. The one or more metal or metal oxide layers 310 and/or one or more insulator layers 320 can be deposited via thermal evaporation, e-beam evaporation, and/or sputtering. In some implementations, masking is required either before (thermal and e-beam evaporation) or after the deposition (sputtering).

As illustrated in FIG. 10C, the one or more metal or metal oxide layers 310 and/or one or more insulator layers 320 can be deposited on the release layer 701 and within the plurality of cavities 710. At least one of the one or more insulator layers 320 can be disposed between the one or more metal or metal oxide layers 310. As illustrated in FIG. 10C, at least one of the one or more insulator layers 320 can be disposed between the one or more metal or metal oxide layers 310 and the release layer 701. For example, an insulator layer 320 can be deposited directly on the release layer 701 to be between at least one of the one or more metal or metal oxide layers 310 and the release layer 701.

In some implementations, an adhesion layer 333 can be disposed between the insulator layers 320 and the metal or metal oxide layers 310 and/or between the substrate base 200 and the insulator layers 320 or the metal or metal oxide layers 310 to improve an adhesion between the metal or metal oxide layers 310, the insulator layers 320, and/or the release layer 701.

Operation 930 includes removing the nanopatterned structure. For example, as illustrated in FIG. 10D, removing the nanopatterned structure can include removing the NIL resist 725 from the base substrate 750 and/or the release layer 701. The NIL resist 725 can be remove using solvents and/or mechanical processes. For example, the NIL resist 725 can be removed by dissolving the NIL 725 in acetone and/or subjecting the NIL resist 725 to sonification.

Operation 940 includes depositing a carrying film 780 over the plurality of MIM nanostructures. For example, as illustrated in FIG. 10E, a polymer, such as poly(methylglutarimide) (PMGI) or polymethyl methacrylate (PMMA), can be spin-coated on top of the plurality of MIM nanostructures 300 and the release layer 701 to form a carrying film 780. The plurality of MIM nanostructures 300 can be bonded to the carrying film 780. In other implementations, the carrying film 780 includes a water-insoluble polymer, such as polystyrene or polyimide.

Operation 950 includes lifting the plurality of MIM nanostructures. For example, operation 950 can include removing the release layer 701 and the base substrate 750 and lifting the carrying film 780 with the plurality of MIM nanostructures 300 using a tape 785. For example, as illustrated in FIG. 10F, the release layer 701 can be etched away to release the plurality of MIM nanostructures 300 bonded to the polymer layer 780 from the base substrate 750. The release layer 701 can be etched in water or in any other suitable solvent. The carrying film 780 can then be peeled-off using a tape 785, such as a water-soluble tape.

Operation 960 includes transferring the plurality of MIM nanostructures to a substrate base. For example, operation 960 includes transferring the plurality of MIM nanostructures 300 to a substrate base 200. The substrate base 200 can be an elastomer, and the substrate base 200 can be pre-stretched to a predetermined length. In one implementation, the substrate base 200 is pre-stretched to a second length 201. The substrate base 200 can be stretched by clamping. In some implementations, the substrate base 200 and/or the plurality of MIM nanostructures 300 can be hydroxyl functionalized to enhance bonding. Accordingly, transferring the plurality of MIM nanostructures to a stretched substrate base can include hydroxyl functionalizing at least one of the substrate base 200 or the plurality of MIM nanostructures 300. For example, a lower surface of the plurality of MIM nanostructures 300 bonded to the carrying film 780 can be exposed to oxygen plasma. The substrate base 200 can be similarly prepared for bonding to the plurality of MIM nanostructures 300 by exposure to oxygen plasma. Exposure to oxygen plasma can create hydroxyl groups on a top surface of the substrate base 200 and a lower surface of the plurality of MIM nanostructures 300. The hydroxyl groups can then form irreversible bonding between these surfaces when they are pressed together.

As illustrated in FIGS. 10G, operation 960 includes depositing the plurality of MIM nanostructures 300 bonded to the carrying film 780 onto the stretched substrate base 200. The plurality of MIM nanostructures 300 and the substrate base 200 can be exposed to oxygen plasma to enhance their bonding. For example, as illustrated in FIG. 10C, a lower surface of the MIM nanostructure 300 can include an insulator layer 320. The insulator layer 320 at a lower surface of the MIM microstructure 300 can then be hydroxyl functionalized to enhance bonding.

Transferring the MIM nanostructures to a substrate base can further include removing the carrying film 780 and the tape 785. For example, the carrying film 780 and tape 785 can be removed in water and/or alkaline developer, such as MF 26A (Kayaku Advanced Materials) to leave the only the plurality of MIM nanostructures 300 on the stretched substrate base 200.

Operation 970 includes releasing the stretched substrate base. For example, in operation 970 the stretched substrate base 200 can be released to contract to a first length 202. The first length 202 is smaller than the second length 201. The first length 202 is configured to reduce an average distance 250 between the plurality of MIM nanostructures 300 disposed on the substrate base 200. In one implementation, an average distance 250 between the plurality of MIM nanostructures 300 disposed on the substrate base 200 is from about 1 nm to about 10 nm. For example, the average distance 250 between the plurality of MIM nanostructures 300 is from about 1 nm to about 5 nm.

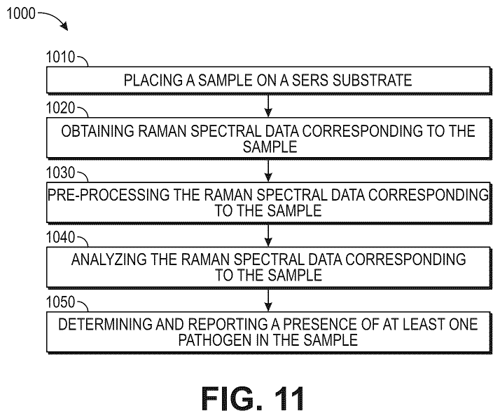

FIG. 11 illustrates a method of detecting at least one pathogen using a SERS substrate according to implementations of the present disclosure. The method illustrated in FIG. 11, for instance, could use a SERS substrate 100 as described above and as illustrated in FIGS. 1-6. As such, the discussion below will reference various components as illustrated in FIGS. 1-6.

As illustrated in FIGS. 11-14, a method 1000 of detecting at least one pathogen using a SERS substrate includes placing a sample on a SERS substrate in operation 1010. The sample is capable of carrying a pathogen. For example, the sample can include at least one of blood plasma, a nasal swab, saliva, tears, urine, or another bodily fluid capable of carrying a pathogen.

In some implementations, placing the sample on a SERS substrate 100 includes directly placing the sample on a SERS substrate 100 by sneezing, coughing, or blowing a sample of a bodily fluid on the SERS substrate 100. In other implementations, the sample can be drop casted or dripped directly on the SERS substrate 100.

Placing a sample on a SERS substrate 100 can include preparing the sample. Preparing the sample can include at least one of diluting the sample, centrifuging, and concentrating the sample, filtering the sample, or chemically or physically treating the sample before it is placed on the SERS substrate 100. For example, the sample can be treated to form a dried droplet to reduce pathogen or virus diffusion in the sample droplet. In other implementations, the sample is in liquid form and treated to concentrate the pathogen for higher sensitivity or measurement when only a low volume of the sample is available.

In other implementations, the sample requires minimum processing. For example, the sample only requires drop casting at the desired location on the SERS substrate 100 before obtaining Raman spectral data corresponding to the sample as described below. The sample may be a label-free sample.

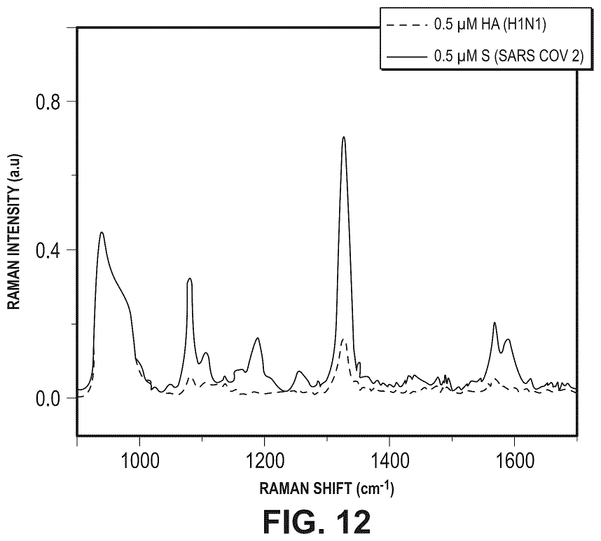

Operation 1020 includes obtaining Raman spectral data corresponding to the sample. Obtaining Raman spectral data corresponding to the sample can include measuring a SERS spectrum of the sample in liquid form or dried droplet. For example, a laser can be focused on an area of interest using an objective lens/portable Raman setup and scattered light can be collected using a detector. FIG. 12 illustrates a Raman spectra according to implementations of the present disclosure. In particular, FIG. 12 illustrates a profile of Raman intensity (a.u.) against a Raman Shift for both purified Hemagglutinin (HA) protein (envelope protein of H1N1 virus) and Spike protein (envelope protein of SARS-CoV2) using a SERS substrate 100 according to implementations of the present disclosure. As illustrated in FIG. 12, directly from the Raman spectra different pathogens can be distinguished based on their purified envelope protein signatures.

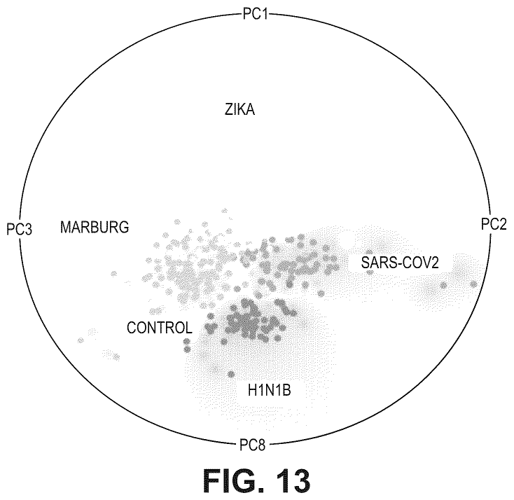

Measuring the SERS spectrum of the sample can include creating a visualization plot and feature extraction and optimization by principal component analysis, K-mean clustering, or other visualization algorithms. FIG. 13 illustrates a Principal Component Analysis for Raman spectral dataset of different virus samples according to implementations of the present disclosure. As illustrated in FIG. 13, a radial visualization plot of the most relevant Principal Component scores demonstrates the clustering of the different pathogens, namely—influenza virus, Marburg Marburgvirus, SARS-CoV2, Zika virus along with a control media containing no pathogen.

Operation 1030 includes pre-processing the Raman spectral data corresponding to the sample. Pre-processing the Raman spectral data corresponding to the sample can include background correcting and normalizing the Raman spectral data. For example, by adjusting for differences in peak positions, ratios, and bandwidths. Adjusting for differences in peak positions, ratios, and bandwidths can remove any interference from unwanted signal coming from the SERS substrate 100 itself or fluorescence background due to the metal nanostructures or fluctuations in laser power.

The pre-processing the Raman spectral data corresponding to the sample can further include creating at least one of a training set, a validation set, or a test set. Training datasets are observations (Raman spectral signatures of the pathogens) used to determine the optimized set of parameters for building a machine learning model. A part of the training dataset is held back and is not used for building the model. This set known as the cross-validation set is used to evaluate the performance of the machine learning model optimized in the previous step. Finally, the test dataset (dataset not used for building the machine learning model) is applied to the model to check its accuracy. The dataset can include Raman spectra acquired from the pathogen containing samples on the SERS substrate 100.

Operation 1040 includes analyzing the Raman spectral data corresponding to the sample. Analyzing the Raman spectral data corresponding to the sample can include analyzing the Raman spectral data by machine learning analysis and validated at least one of a training set, a validation set, or a test set to detect the presence of at least one pathogen in the sample. For example, a training set including Raman spectral data acquired from the pathogen containing samples along with their known labels (i.e., the sample identities) can be used with an appropriate algorithm (such as logistic regression, support vector machine, random forest/decision tree or other supervised machine learning models) such that the parameters for the classification function are obtained (known as the training step). K-fold/leave-n-out cross validation can be used to optimize the model parameters of the machine learning analysis and assess the model performance (cross-validation step). Finally, quantitative measures of validation (accuracy or error) can be obtained using an independent sample set for validation of the protocol (test step). Prediction of class label of the unknown sample can involve the model developed in the training step and the spectral data obtained from this sample. The predicted class label can then be compared with the ground truth (such as RT-PCR determination of virus/pathogen ID).

In some implementations, analyzing the Raman spectral data corresponding to the sample can include obtaining a molecular vibration fingerprint for one or more pathogens present in the sample directly from the spectral data or using machine learning classifiers to extract or identify the significant molecular signatures of the pathogen.

In one implementation, the machine learning analysis compares a fingerprint in the Raman spectral data corresponding to the sample to a validated set to identify one or more pathogens present in the sample. In another implementation, the machine learning analysis compares a fingerprint in the Raman spectral data corresponding to the sample to distinguish different pathogens in a mixture sample containing two or more varieties of the pathogen.

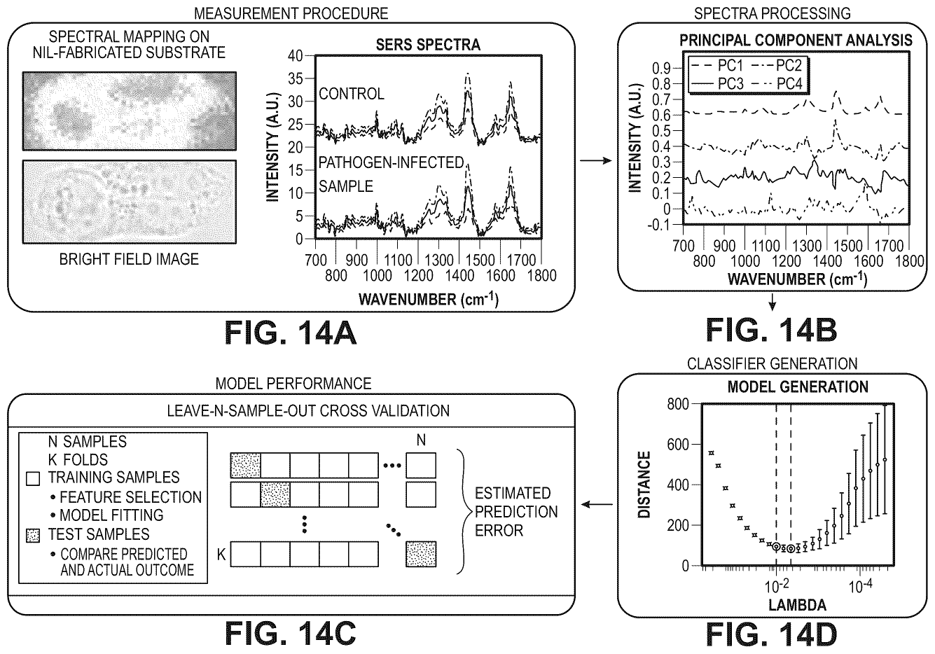

FIGS. 14A-D illustrates machine learning analysis according to an implementation of the present disclosure. As illustrated in FIG. 14, the steps of machine learning analysis include obtaining Raman spectral data corresponding to the sample as illustrated in FIG. 14A; pre-processing, feature extraction and visualization of the Raman spectral data corresponding to the sample as illustrated in FIG. 14B (via principal component analysis (PCA)); building a classifier as illustrated in FIG. 14C, and evaluating model performance through leave-n-sample-out cross-validation as illustrated in FIG. 14D.

Operation 1050 includes determining and reporting a presence of at least one pathogen in the sample. Determining and reporting a presence of at least one pathogen in the sample can include determining a presence of at least one pathogen in the sample in 1 hour or less, 50 minutes or less, 40 minutes or less, 30 minutes or less, 20 minutes or less, 10 minutes or less.

In one implementation, a pathogen detection threshold is at least 95 copies/ml. For example, method 1000 can have a pathogen detection threshold of at least 100 copies/ml, of at least 10³ copies/ml, or of at least 10⁷ copies/ml. In another implementation, the pathogen detection threshold is from about 95 copies/ml to about 10²⁰ copies/ml.

Aspects of the present disclosure may be further understood by referring to the following examples. The examples are illustrative and are not intended to be limiting.

Example 1 illustrates a method of making a rigid SERS substrate according to one implementation of the present disclosure. Example 2 illustrates a method of making a flexible SERS substrate according to one implementation of the present disclosure.

### Example 1

A rigid SERS substrate 100 was formed as follows: A 350 nm layer of NIL resist (mr-I 7030, micro resist technology) was spin coated on top of a silicon wafer. The NIL resist was then nanopatterned using a commercial, low cost, Si master stamp (LightSmyth grating) and a Nanonex Advanced Nanoimprint Tool NX-B200. After patterning, residue was removed, and a plurality of cavities was defined using an oxygen (O₂) plasma at 60 W for 2 minutes. A plurality of MIM nanostructures were then formed within the plurality of cavities patterned in the NIL resist by depositing layers of silver (Ag, 20 nm), silicon dioxide (SiO₂, 10 nm), and silver (Ag, 20 nm) by e-beam evaporation. 2 nm of chromium (Cr) was deposited between the silicon wafer and the Ag layer and in between each layer of Ag and SiO₂ and SiO₂ and Ag to improve adhesion. After forming the MIM nanostructures, the NIL resist was removed by sonification in an acetone solution to form an array of MIM nanostructures on a Si wafer.

### Example 2

A flexible SERS substrate 100 was formed as follows: A 100 nm thin film of germanium (Ge) was thermally evaporated on a Si wafer as a release layer. A plurality of MIM nanostructures was then form on top of the Ge layer using the same approach as in Example 1. A layers of polymethylglutarimide (PMGI SF6, Kayaku Advanced Materials) was then spin coated as a carrying film over the plurality of MIM nanostructures. The Ge release layer was then etched away in water, and the carrying film with the plurality of MIM nanostructures was picked up using a mm-scale thick piece of PDMS. After the carrying film was dried, it was separated from the PDMS using a water-soluble tape (3M 5414). The surfaces of the bottom of the MIM nanostructures (SiO₂) and an elastomer base (Dragon Skin™) were then activated by exposure to O₂ plasma. The elastomer base was stretched and then the MIM nanostructures were bonded to the elastomer base by pressing both surfaces together and removing the water-soluble tape and the PMGI in water and alkaline developer. The elastomer base was then released to decrease an average distance between the MIM nanostructures.

The present disclosure has been described with reference to exemplary implementations. Although a few implementations have been shown and described, it will be appreciated by those skilled in the art that changes can be made in these implementations without departing from the principles and spirit of preceding detailed description. It is intended that the present disclosure be construed as including all such modifications and alterations insofar as they come within the scope of the appended claims or the equivalents thereof.

What is claimed, is:

1. A surface-enhanced Raman spectroscopy (SERS) substrate, comprising:
a substrate base; and
a plurality of metal insulator metal (MIM) nanostructures disposed on the substrate base,
wherein an average distance between the plurality of MM nanostructures disposed on the substrate base is from about 1 nm to about 10 nm,
wherein each of the plurality of MIM nanostructures comprises one or more metal or metal oxide layers and one or more insulator layers, and
wherein each of the one or more metal or metal oxide layers has an average thickness from about 20 nm to about 60 nm and each of the one or more insulator layers has an average thickness from about 5 nm to about 10 nm.

2. The SERS substrate of claim 1, wherein the SERS substrate is configured to produce a Raman spectrum corresponding to a pathogen sample when examined under a Raman spectroscope.

3. The SERS substrate of claim 1, wherein at least one of the one or more insulator layers is disposed directly on the substrate base between at least one of the one or more metal or metal oxide layers and the substrate base.

4. The SERS substrate of claim 1, wherein at least one of the plurality of MIM nanostructures has two or more metal or metal oxide layers, and wherein at least one of the one or more insulator layers is disposed between the two or more metal or metal oxide layers.

5. The SERS substrate of claim 1, wherein at least half of the plurality of MIM nanostructures has three or more metal or metal oxide layers.

6. The SERS substrate of claim 1, wherein the plurality of MIM nanostructures exhibit plasmonic activity in response to electromagnetic excitations having a frequency corresponding to a plasmon resonance frequency of the plurality of MIM nanostructures.

7. The SERS substrate of claim 1, wherein the substrate base is flexible and comprises an elastomer, the elastomer comprising one or more of a flexible polymer, silicone, polysiloxane, latex, or combinations thereof.

8. The SERS substrate of claim 1, wherein the one or more metal or metal oxide layers comprise at least one of gold, silver, copper, aluminum, or alloys or combinations thereof, and wherein the plurality of MIM nanostructures further comprise one or more adhesion layers disposed between at least two of the one or more insulator layers, the one or more metal or metal oxide layers, or the substrate base.

9. The SERS substrate of claim 1, wherein the one or more metal or metal oxide layers comprise at least one Al/Ge doped zinc oxides, heavily doped indium tin oxides, metal nitrides, graphene, molybdenum disulfide, tungsten disulfide, or combinations thereof.

10. The SERS substrate of claim 1, wherein the one or more insulator layers comprise at least one of aluminum oxide, indium tin oxide, tin oxide, silicon dioxide, zinc oxide, or combinations thereof.

11. The SERS substrate of claim 1, wherein at least one of the substrate base and the at least one of the one or more insulator layers is disposed directly on the substrate base is hydroxyl functionalized.

12. A Surface Enhanced Raman Spectroscopy (SERS) biosensor, comprising the SERS substrate of claim 1,
wherein the SERS biosensor is configured to produce a Raman spectrum corresponding to a pathogen sample when examined under a Raman spectroscope.

13. A method for making a surface-enhanced Raman spectroscopy (SERS) substrate, comprising:
creating a nanopatterned structure;
depositing a plurality of MM nanostructures on the nanopatterned structure;
removing the nanopatterned structure;
depositing a carrying film over the plurality of MIM nanostructures;
lifting the plurality of MIM nanostructures;
transferring the plurality of MM nanostructures to a stretched substrate base; and
releasing the stretched substrate base,
wherein after releasing the stretched substrate base, an average distance between the plurality of MM nanostructures on the substrate base is from about 1 nm to about 10 nm,
wherein each of the plurality of MIM nanostructures comprises one or more metal or metal oxide layers and one or more insulator layers, and
wherein each of the one or more metal or metal oxide layers has an average thickness from about 20 nm to about 60 nm and each of the one or more insulator layers has an average thickness from about 5 nm to about 10 nm.

14. The method of claim 13, wherein after releasing the stretched substrate base, at least one of the one or more insulator layers is disposed directly on the substrate base between at least one of the one or more metal or metal oxide layers and the substrate base.

15. The method of claim 13, wherein creating a nanopatterned structure comprises using nanoimprint lithography to create a nanopatterned structure.

16. The method of claim 13, wherein transferring the plurality of MM nanostructures to a stretched substrate base comprises hydroxyl functionalizing at least one of the substrate base or the plurality of MM nanostructures.

17. A method of detecting at least one pathogen using a SERS substrate, comprising:
placing a sample on a SERS substrate;
obtaining Raman spectral data corresponding to the sample;
pre-processing the Raman spectral data corresponding to the sample;
analyzing the Raman spectral data corresponding to the sample; and
determining and reporting a presence of at least one pathogen in the sample,
wherein the SERS substrate comprises:
a substrate base; and
a plurality of metal insulator metal (MIM) nanostructures disposed on the substrate base,
wherein an average distance between the plurality of MIM nanostructures disposed on the substrate base is from about 1 nm to about 10 nm,
wherein each of the plurality of MIM nanostructures comprises one or more metal or metal oxide layers and one or more insulator layers.

18. The method of claim 17, wherein each of the one or more metal or metal oxide layers has an average thickness from about 20 nm to about 60 nm and each of the one or more insulator layers has an average thickness from about 5 nm to about 10 nm.

19. The method of claim 17, wherein pre-processing the Raman spectral data corresponding to the sample comprises background correcting and normalizing the Raman spectral data and creating at least one of a training set, a validation set, or a test set.

20. The method of claim 19, wherein analyzing the Raman spectral data corresponding to the sample comprises analyzing the Raman spectral data by machine learning analysis and validated at least one of a training set, a validation set, or a test set to detect the presence of at least one pathogen in the sample.
